(19) United States
(12) Patent Application Publication
(10) Pub. No.: US 2004/0180747 A1
(43) Pub. Date: Sep. 16, 2004

(54) Transfer case having input shaft electromagnetic brake

(76) Inventors: David R. Weilant, Muncie, IN (US); Wayne E. Wyant, Alexandria, IN (US)

Correspondence Address: BORG WARNER INC., 3800 AUTOMATION AVENUE, SUITE 100, POWERTRAIN TECHNICAL CENTER, AUBURN HILLS, MI, 48236, US

(21) Appl. No.: 10/389,323

(22) Filed: Mar. 14, 2003

(51) Int. Cl. F16H 48/06

(52) U.S. Cl. 475/154

(57) ABSTRACT

A motor vehicle transfer case includes an input shaft and an electromagnetic brake for retarding rotation of the input shaft. An electromagnetic coil is mounted to the front of the transfer case about the input shaft. An armature plate is secured to the input shaft adjacent the electromagnetic coil. Energization of the coil retards rotation of the input shaft and cancels neutral drag torque from the transmission thereby eliminating relative rotation between the shifting elements of the transfer case and providing smoother shifts.

### BACKGROUND OF THE INVENTION

The invention relates generally to motor vehicle transfer cases and more particularly to an electromagnetic brake for the input shaft of a motor vehicle transfer case.

The majority of four-wheel drive motor vehicles and virtually every sport utility vehicle or pick-up truck equipped with four-wheel drive utilizes a transfer case coupled to the output of the transmission to distribute drive torque to the front and rear axles of the vehicle. These transfer cases incorporate many diverse mechanical devices which may provide, among other features, a reduced speed (low gear) drive mode, interaxle speed differentiation and manual or automatic engagement of an interaxle clutch to intermittently reduce prop shaft speed differences or positively drive front and rear prop shafts.

Significant developments have been made with regard to systems which sense wheel speed differences and engage interaxle clutches to reduce such speed differences. An automatically engaging system is disclosed, for example, in co-owned U.S. Pat. No. 5,407,024.

In addition to developments directed to enhancing the flexibility and operation of such transfer cases are developments directed to providing smooth, seamless and imperceptible operation of the components of the transfer case—not only interaxle clutch engagement—but also selection of operating ranges. The present invention is directed to such a feature.

### SUMMARY OF THE INVENTION

A motor vehicle transfer case includes an input shaft and an electromagnetic brake for retarding rotation of the input shaft. An electromagnetic coil is mounted to the front of the transfer case about the input shaft. A circular armature plate is secured to the input shaft adjacent the electromagnetic coil. Energization of the coil retards rotation of the input shaft and cancels neutral drag torque from the transmission thereby eliminating relative rotation between the shifting elements of the transfer case and providing smoother shifts. A speed sensor on the input shaft provides data to a microprocessor that utilizes such data to command shifts at or near synchronization.

Thus it is an object of the present invention to provide a transfer case having an electromagnetic brake.

It is a further object of the present invention to provide a transfer case having an electromagnetic brake for retarding motion of the input shaft.

It is a still further object of the present invention to provide an electromagnetic coil disposed about the input shaft of a transfer case for retarding motion thereof.

It is a still further object of the present invention to provide an electromagnetic brake on the input shaft of a transfer case that cancels neutral drag torque from the vehicle transmission.

Further objects and advantages of the present invention will become apparent by reference to the following description of the preferred embodiment and appended drawings wherein like reference numbers refer to the same component, element or feature.

### BRIEF DESCRIPTION OF THE DRAWINGS

FIG. 1 is a diagrammatic view of a motor vehicle power train having a transfer case incorporating the present invention

FIG. 2 is a side, elevational view in partial section of a motor vehicle transfer case incorporating the present invention;

FIG. 3 is an enlarged, fragmentary view of a motor vehicle transfer case incorporating the present invention;

FIG. 4 is a front, elevational view of an armature of an electromagnetic transfer case brake according to the present invention; and

FIG. 5 is a fragmentary view of the housing of an electromagnetic coil according to the present invention.

### DETAILED DESCRIPTION OF THE PREFERRED EMBODIMENT

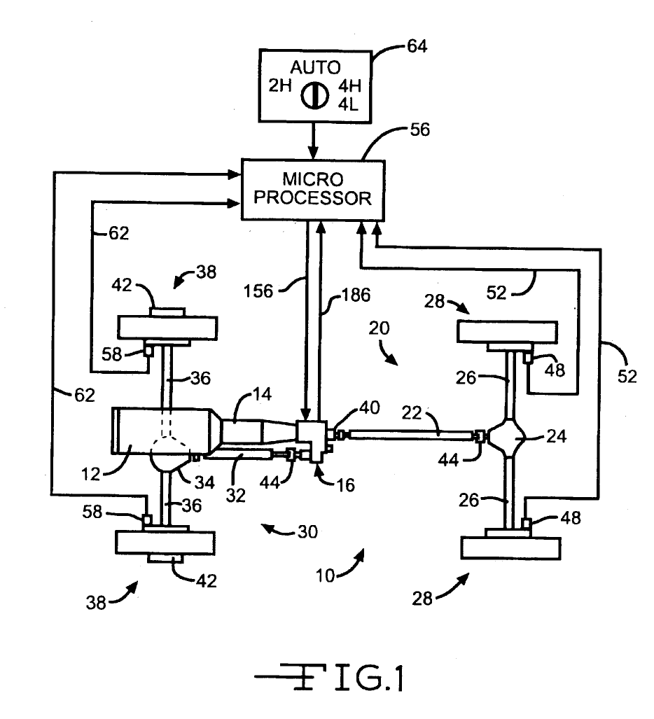

Referring now to FIG. 1, a four-wheel vehicle drive train which may utilize the present invention is diagrammatically illustrated and designated by the reference number 10. The four-wheel vehicle drive train 10 includes a prime mover 12 such as an internal combustion engine having an output which is coupled to and directly drives a transmission 14. The output of the transmission 14 directly drives a transfer case assembly 16 which provides motive power to a primary or rear drive driveline 20 comprising a primary or rear prop shaft 22, a primary or rear differential 24, a pair of live primary or rear axles 26 and a respective pair of primary or rear tire and wheel assemblies 28.

The transfer case assembly 16 also selectively provides motive power to a secondary or front driveline 30 comprising a secondary or front prop shaft 32, a secondary or front differential 34, a pair of live secondary or front axles 36 and a respective pair of secondary or front tire and wheel assemblies 38. The front tire and wheel assemblies 38 may be directly coupled to a respective one of the front axles 36 or, if desired, a pair of manually or remotely activatable locking hubs 42 may be operably disposed between the front axles 36 and a respective one of the tire and wheel assemblies 38 to selectively connect same. Finally, both the primary driveline 20 and the secondary driveline 30 may include suitable and appropriately disposed universal joints 44 which function in conventional fashion to allow static and dynamic offsets and misalignments between the various shafts and components.

Disposed in sensing relationship with each of the rear tire and wheel assemblies 28 is a wheel speed sensor 48. Preferably, the wheel speed sensors 48 may be the same sensors utilized with, for example, an antilock brake system (ABS) or other vehicle control or traction enhancing system. Alternatively, a single sensor, disposed to sense rotation of the primary or rear prop shaft 22 may be utilized. Signals from the sensors 48 are provided in lines 52 to a microprocessor 56. Similarly, disposed in sensing relationship with the front tire and wheel assemblies 38 are respective wheel speed sensors 58 which provide signals to the microprocessor 56 in lines 62. Once again, the sensors 58 may be a part of or shared with an antilock brake system or other traction enhancing system.

Typically, an operator selectable switch 64 may be utilized and is generally disposed within reach of the vehicle operator in the passenger compartment (not illustrated). The switch 64 may be adjusted to select various operating modes such as two-wheel high gear, automatic, i.e., on-demand or adaptive operation, four-wheel high gear or four-wheel low gear depending upon the particular vehicle and configuration of the transfer case assembly 16. One such system which provides torque delivery to the secondary driveline 30 in increments or decrements in response to a sensed wheel speed difference between the primary driveline 20 and the secondary driveline 30 is disclosed in U.S. Pat. No. 5,407,024.

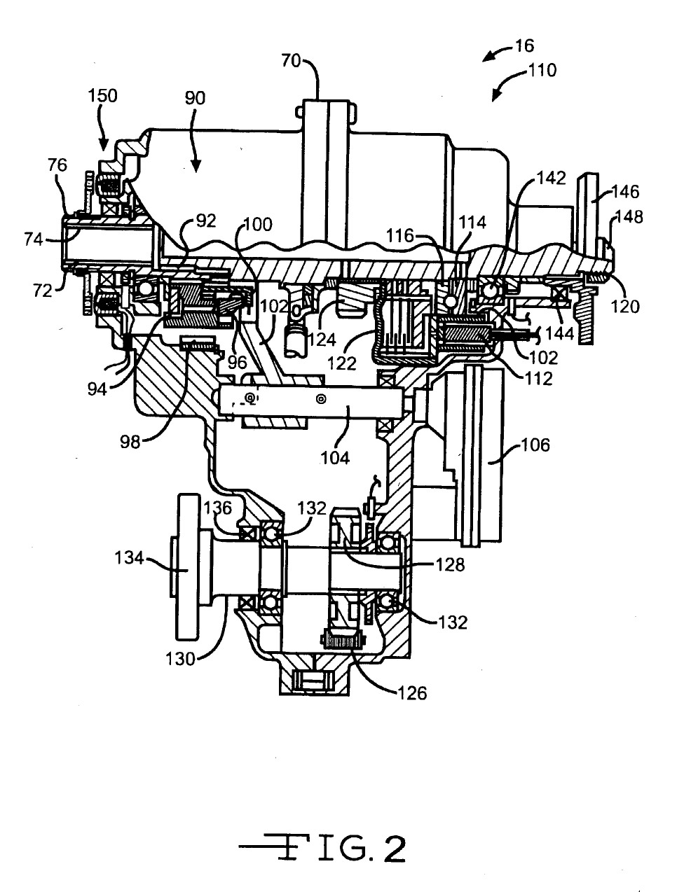

Referring now to FIG. 2, the transfer case assembly 16 includes a multiple piece, cast metal housing 70 having multiple and diverse openings, apertures, counter bores, ledges, slots and planar surfaces for receiving gaskets, seals and various fixed and rotating components of the transfer case assembly 16 as will be readily appreciated. Among those components is an input shaft 72 having a plurality of female splines or internal gear teeth 74 which receives a complementarily splined output shaft (not illustrated) of the transmission 14 illustrated in FIG. 1. The input shaft 72 also includes a region of male splines or external gear teeth 76. The input shaft 72 also includes a circumferential channel or groove 78 formed in the male splines or gear teeth 76. An oil seal 82 provides a fluid-tight seal between the input shaft 72 and the housing 70. The input shaft 72 is rotatably supported upon an anti-friction bearing such as a ball bearing assembly 84.

The transfer case assembly 16 also includes a speed reducing planetary gear assembly 90. The speed reducing planetary gear assembly 90 is conventional and includes a sun gear 92 which constantly engages and drives a plurality of planet gears 94 rotatably mounted within a carrier 96 and in constant engagement with a ring gear 98. A clutch or shift collar 100 may be translated axially by a shift fork 102 to provide direct, high speed drive when engaging the input shaft 72 and a reduced speed, low range drive when engaging the carrier 96. The shift fork 102 is axially, bi-directionally translated through the interaction of helical cams 104 and followers associated with a rotating shift rail 106 which is driven by a bi-directional electric motor drive assembly 108.

The transfer case assembly 16 also includes an electromagnetic clutch assembly 110 having an electromagnetic coil assembly 112 which cooperates with a ball ramp operator assembly 114 to compress a friction clutch pack assembly 116. The friction clutch pack assembly 116 includes a first plurality of clutch disks splined to a primary output shaft 120 and a second plurality of interleaved clutch plates or disks splined to a bell-shaped housing 122 which is drivingly coupled to a first chain drive sprocket 124. The chain drive sprocket 124 engages a drive chain 126 which extends about and drives a second chain sprocket 128 which is coupled by engaging splines or other positive connecting means to a secondary output shaft 130. The secondary output shaft 130 is rotatably supported by a pair of anti-friction bearings such as ball bearing assemblies 132 and may include a flange 134 which may be a portion of one of the universal joints 44 illustrated in FIG. 1. An oil seal 136 provides a suitable fluid tight seal between the secondary output shaft 130 and the transfer case housing 70. A ball bearing assembly 142 rotatably supports the primary output shaft 120 and an oil seal 144 provides a suitable fluid tight seal between the primary output shaft 120 and the transfer case housing 70. An output flange 146 may be secured to the primary output shaft 120 by a fastener such as a nut 148. Once again, the flange 146 may form a portion of one of the universal joints 44 illustrated in FIG. 1.

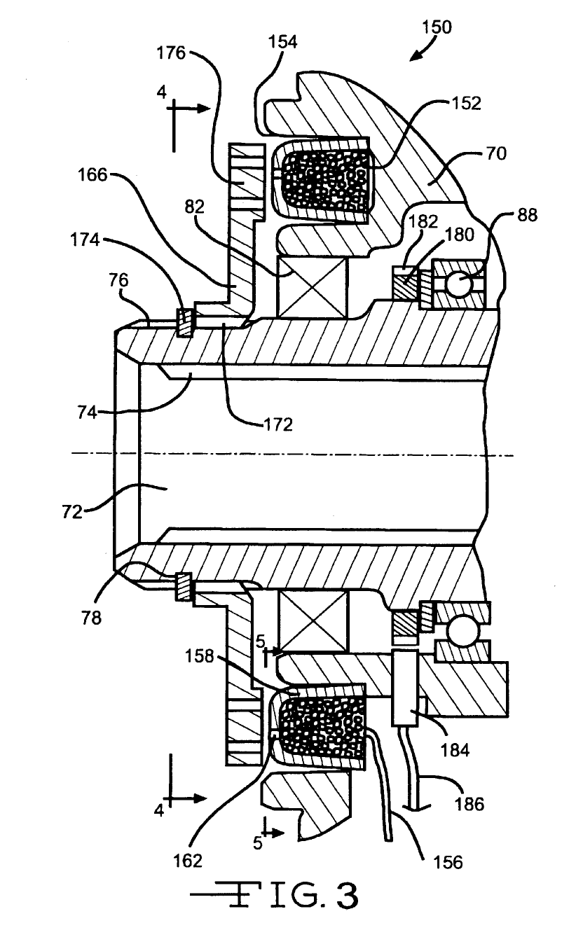

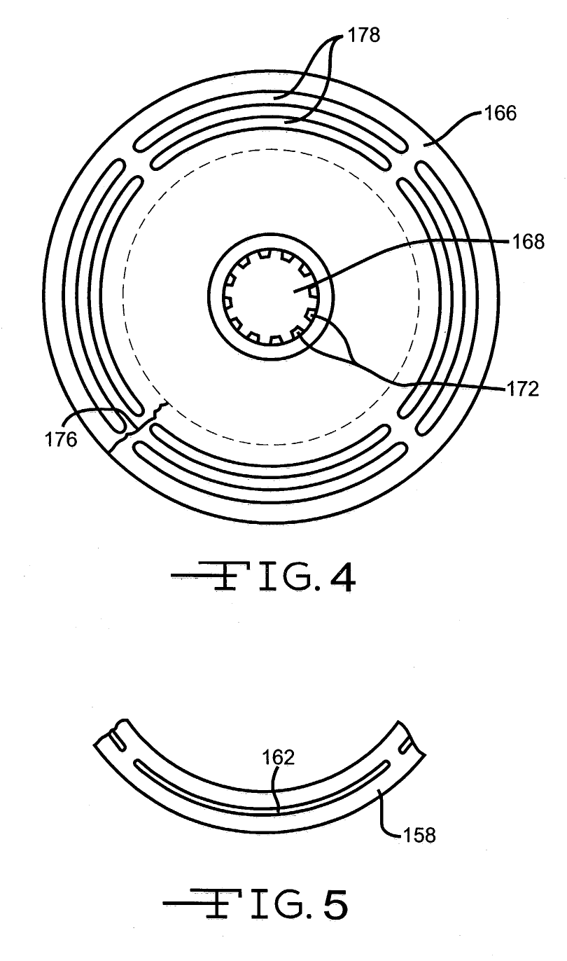

Referring now to FIGS. 3, 4, and 5, an electromagnetic brake assembly 150 is illustrated and includes an electromagnetic coil 152 disposed in an annular channel 154 formed in the forward portion of the transfer case housing 70. The electromagnetic coil 152 is provided with energy through an electrical conductor 156. The electromagnetic coil 152 is preferably disposed within a metallic coil housing 158 having a plurality of flux concentrating arcuate (banana) slots 162 arranged end to end in a circle as partially illustrated in FIG. 5.

Disposed adjacent the front of the housing 158 for the electromagnetic coil 152 is a circular armature 166 defining a through circular opening or bore 168 having side walls defining a plurality of internal or female splines or gear teeth 172. The splines or gear teeth 172 are complementary to those external splines or gear teeth 76 on the input shaft 72. The circular armature 166 is retained upon the input shaft 72 by a snap ring 174 or similar, suitable retainer which is received within the circumferential groove 78 on the input shaft 72. The circular armature 166 includes a region of enhanced thickness 176 generally aligned with the electromagnetic coil housing 158. Included in the region of enhanced thickness 176 and generally aligned with the actuate banana slots 162 in the coil housing 158 are a plurality of radially spaced apart pairs of arcuate banana slots 178 having nominal diameters slightly larger than and slightly smaller than the nominal diameter of the banana slots 162 in the electromagnetic coil housing 158.

Positively secured to the input shaft 72 is a counting or tone wheel 180 having a plurality of equally spaced apart teeth 182. The tone wheel 180 may preferably be secured to the input shaft 72 by an interference fit or other positive means such as spot welding or splines. Disposed in sensing relationship with the tone wheel 180 is a variable reluctance, Hall Effect or optical sensor 184. The tone wheel 180 and the sensor 184 function as a tachometer to provide data or information in a cable 186 regarding the speed of the input shaft 72.

In operation, the electromagnetic brake assembly 150 according to the present invention improves the seamlessness and smoothness of shifts within the transfer case assembly 16 by canceling out neutral drag torque from the transmission 14 and synchronizing the input shaft 72 or the planetary carrier 96 and the primary output shaft 120 across which the clutch or shift collar 100 operates. For example, when a shift is to be undertaken by components of the transfer case assembly 16, the electromagnetic coil 152 may be energized in a modulating or proportional fashion to retard motion of the input shaft 72 to the extent necessary to bring the components to be shifted substantially or fully into synchronism not only to facilitate the shift but also to render it smooth, and to the extent possible, imperceptible. Such modulation may be achieved by pulse width modulated (PWM) electrical control or control of the electrical signal provided to the electromagnetic coil 152 or any other drive system which provides modulating or proportional control of the intensity or level of the electrical signal provided to the electromagnetic coil 152.

As noted, the speed reducing planetary gear assembly 90 provides a reduced speed operating mode (low gear) when the clutch collar 100 is moved to the right (as illustrated in FIG. 2) by the electric motor drive assembly 108 to engage the carrier 96 and provides a direct operating mode (high gear) when the clutch collar 100 is moved to the left (as illustrated in FIG. 2) to engage the sun gear 92.

The speed sensor 184 provides information to the microprocessor 56 regarding the speed of the input shaft 72 and the extent of braking or speed reduction provided by the electromagnetic brake assembly 150. It will be appreciated that speed of the output shaft 120 may be provided by signals from the wheel speed sensors 48 which are averaged or may also be provided by a speed sensor (not illustrated) which senses the rotational speed of the output shaft 120. The microprocessor 56 utilities such information to determine the optimal time to initiate or sequence shifts or shift commands by the electric motor drive assembly 108 within the transfer case assembly 16 thereby improving, as noted, the smoothness of shifts by the clutch collar 100.

It should be appreciated that while the invention has been described in connection with a transfer case assembly 16 having a planetary gear speed reduction assembly 90 which provides a low gear or reduced speed drive in addition to a high speed direct drive, but not an interaxle differential, it should be appreciated that the present invention is adaptable to and will function equally well with a transfer case incorporating an interaxle differential. Moreover, while the invention has been described in connection with a electromagnetic modulating clutch assembly 110 for providing proportional or modulating torque transfer from the primary driveline 20 to the secondary driveline 30, having a ball ramp assembly 114 operator, it should be appreciated that numerous other modulating clutch designs having bidirectional operators, levers and cam linkages, electromagnetic coils operating directly upon the friction clutch pack and hydraulically or pneumatically operated clutches will function equally well and are within the scope of the invention.

The foregoing disclosure is the best mode devised by the inventors for practicing this invention. It is apparent, however, that devices incorporating modifications and variations will be obvious to one skilled in the art of transfer case brakes and clutches. Inasmuch as the foregoing disclosure is intended to enable one skilled in the pertinent art to practice the instant invention, it should not be construed to be limited thereby but should be construed to include such aforementioned obvious variations and be limited only by the scope and spirit of the following claims.

I claim:

1. A transfer case comprising, in combination,
an input shaft;
a speed reduction gearset having an input coupled to said input shaft and an output;
a primary output shaft;
a range selector for selectively coupling one of said input shaft and said output of said speed reduction gearset to said primary output shaft;
a secondary output;
a clutch having an input driven by said output shaft and adapted to selectively drive said secondary output; and
an electromagnetic brake for selectively braking said input shaft.

2. The transfer case of claim 1 wherein said electromagnetic brake includes a coil disposed adjacent said input shaft.

3. The transfer case of claim 2 wherein said coil is disposed in a housing and said housing includes a plurality of flux concentrating slots.

4. The transfer case of claim 1 wherein said electromagnetic brake includes a coil disposed about said input shaft and further including an armature coupled to said input shaft and disposed adjacent said coil.

5. The transfer case of claim 4 wherein said armature includes a plurality of flux concentrating slots.

6. The transfer case of claim 1 wherein said armature and said input shaft include pluralities of complementary splines.

7. The transfer case of claim 1 wherein said speed reduction gearset includes a sun gear, a carrier, a plurality of planet gears disposed for rotation in said carrier and a ring gear.

8. A transfer case comprising, in combination,
an input shaft for providing drive torque to a primary driveline;
a secondary output shaft for providing drive torque to a secondary driveline;
a clutch having an input driven by said input shaft and adapted to selectively provide torque to said secondary output shaft; and
an electromagnetic brake assembly for selectively braking said input shaft.

9. The transfer case of claim 8 wherein said electromagnetic brake includes a coil disposed adjacent said input shaft.

10. The transfer case of claim 9 wherein said coil is disposed in a housing and said housing includes a plurality of flux concentrating slots.

11. The transfer case of claim 8 wherein said electromagnetic brake includes a coil disposed about said input shaft and further including an armature coupled to said input shaft and disposed adjacent said coil.

12. The transfer case of claim 11 wherein said armature includes a plurality of flux concentrating slots.

13. The transfer case of claim 8 further including a speed reduction gearset having an input member and an output member and a clutch for selectively driving said input shaft with one of said input member and said output member.

14. A transfer case comprising, in combination,
an input shaft;
a speed reduction gearset having an input coupled to said input shaft and an output;
a primary output shaft;
a range selector for selectively coupling one of said input shaft and said output of said speed reduction gearset to said primary output shaft;
a secondary output;
a clutch having an input driven by said output shaft and adapted to selectively drive said secondary output; and
an electromagnetic brake for selectively braking said input shaft.
